(19) United States
(12) Patent Application Publication
(10) Pub. No.: US 2010/0085511 A1
(43) Pub. Date: Apr. 8, 2010

(54) DISPLAY DEVICE

(76) Inventors: Hisashi Watanabe, Osaka-shi (JP); Takashi Sato, Osaka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/515,467

(22) PCT Filed: Nov. 9, 2007
(86) PCT No.: PCT/JP2007/071818

§ 371 Date: Nov. 2, 2009

(30) Foreign Application Priority Data
Nov. 20, 2006 (JP) 2006-312913

(51) Int. Cl. G02F 1/1335; G02F 1/13357

(52) U.S. Cl. 349/67; 362/97.1

(57) ABSTRACT

A display device of the present invention includes: a display panel 100a including a plurality of pixels arranged in a matrix; a lighting device 50 including a light source 30 and a light guide plate 31 for outputting light toward the front; and a plurality of light condensing elements 54a placed between the display panel and the lighting device. The directivity of light emerging from the lighting device to be incident on the light condensing elements varies with the position in the display panel plane, and when the range of a polar angle of light, out of the light emerging from the lighting device to be incident on the light condensing elements, that is used for display after passing through the light condensing elements and then the display panel, with respect to the normal to the display panel plane determined based on geometrical optics is ±ω or less and the luminous flux within the range of the polar angle ±ω (within ∠AOC) is Φω, the minimum one of values of luminous flux Φω at the centers of nine regions, obtained by dividing a region corresponding to the display region of the display panel plane into nine equal parts, is 70% or more of the maximum one of the values.

### TECHNICAL FIELD

The present invention relates to a display device and more particularly to a non-luminous display device that uses light from a lighting device for display.

### BACKGROUND ART

Types of non-luminous display devices include liquid crystal display devices, electrochromic display devices, electrophoretic display devices and the like. Among others, liquid crystal display devices are in widespread use in personal computers, cellular phones and the like, for example.

Liquid crystal display devices are configured to display images, letters and the like by changing the optical properties of a liquid crystal layer at its pixel openings with a drive voltage applied to each of pixel electrodes arranged regularly in a matrix. In such liquid crystal display devices, for individual control of a plurality of pixels, thin film transistors (TFTs), for example, are provided as switching elements for such pixels. Interconnects are also provided for supply of predetermined signals to such switching elements.

With a transistor provided for each pixel, the area of each pixel decreases, causing a problem of degrading the luminance. Moreover, it is difficult to form switching elements and interconnects having sizes of certain levels or less under the constraints of their electric performance capabilities and fabrication techniques. For example, the etching precision in photolithography has a limitation of about 1 to 10 μm. Hence, as the pitch of pixels becomes smaller with achievement of higher definition and a smaller size in liquid crystal display devices, the aperture ratio further decreases, and this makes the problem of degrading the luminance noticeable.

To solve the problem that the luminance is low, light condensing elements are provided between a liquid crystal display device and a lighting device to condense light from the lighting device on pixels.

For example, Patent Document 1 discloses a transflective (transmissive/reflective) liquid crystal display device having transmission regions and reflection regions that is provided with light condensing elements such as microlenses.

Transflective liquid crystal display devices have been recently developed as liquid crystal display devices suitably usable even in bright environments such as the use environment of cellular phones. A transflective liquid crystal display device has a transmission region adapted to display in a transmission mode using light from a planar lighting device placed on the back (called a “backlight”) and a reflection region adapted to display in a reflection mode using ambient light, for one pixel, and can switch between the transmission-mode display and the reflection-mode display, or conduct both-mode display, depending on the use environment.

Such a transflective liquid crystal display device has a problem that since the reflection region must be wide to some extent, the area ratio of the transmission region to one pixel decreases, and this degrades the luminance in the transmission mode.

To address the above problem, Patent Document 2 discloses a method in which in a transflective liquid crystal display device provided with a reflector having openings and light condensing elements such as microlenses formed on a substrate located closer to a backlight, light from the backlight incident on the microlenses is condensed into the openings of the reflector with high efficiency by placing the reflector and the microlenses on the same surface of the substrate that faces a liquid crystal layer.

Patent Document 3 discloses a method in which the bottom shape of microlenses is circular or hexagonal, and such microlenses and the transmission regions of pixels are both arranged zigzag. Also, the microlenses and the transmission regions of pixels are placed in a one-to-one correspondence with each other in such a manner that the focus of each microlens is located at the center of the transmission region of the corresponding pixel, to thereby enhance the light condensing efficiency (use efficiency of light incident from a lighting device) of the microlenses.

To condense light efficiently with a light condensing element, the parallelism (also called the “directivity”) of light emerging from a lighting device to be incident on the light condensing element is preferably high. However, in medium to small sized liquid crystal display devices, particularly in liquid crystal display devices mounted in mobile equipment, in which an edge-light type backlight is used for thinning and weight-saving, it is difficult to obtain light with high parallelism. The edge-light backlight includes a light guide plate and a light source (a light emitting diode (LED), a fluorescent tube, etc.) that emits light to a side face of the light guide plate, and is configured so that part of light propagating inside the light guide plate while repeating total reflection emerges from the display panel-side of the light guide plate. To allow light propagating inside the light guide plate to emerge from the display panel-side, concave or convex portions are formed on the light guide plate. When light propagating inside the light guide plate is incident on a concave or convex portion, it is reflected from an inclined face of the concave or convex portion (an interface between the light guide plate and the outside) and changes its traveling direction. Part of such light is incident on the light emerging face (principal face on the display-panel side) of the light guide plate at an angle smaller than the critical angle, and as a result, emerges outside the light guide plate. A reflection layer may sometimes be provided on the back of the light guide plate to allow light emerging from the back of the light guide plate to reenter the light guide plate.

Patent Document 4 and Non-Patent Document 1 describe edge-light type backlights capable of outputting light with high directivity. However, while the directivity of light emerging from the edge-light type backlights described in these documents is higher than that conventionally attained, it fails to be as high as the directivity (half-width: ±2°, for example) obtained by a light source used in a projection type liquid crystal display device, for example. Also, the backlights disclosed in the above documents have a problem that the directivity of light emerging from the backlight varies with the azimuth (azimuth in the liquid crystal panel plane). For example, in the backlight described in Non-Patent Document 1, the angular distribution (polar angle) of the luminance is smaller in the X direction than in the Y direction, where the Y direction is a radial direction of a circle having its center at a light source placed on a side face of a light guide plate, and the X direction is orthogonal to the Y direction. For example, while the half-width of the luminance in the X direction is about ±3°, it is about ±15° in the Y direction.

In Patent Document 5, the present inventors disclosed a configuration of a display device using a backlight outputting light whose directivity varies with the azimuth as described in Non-Patent Document 1, with which the light amount passing through pixels increases (the display luminance enhances). To state specifically, the present inventors disclosed that the transmitted light amount could be increased by placing light condensing elements so as to converge light at a point closer to the observer with respect to a display medium layer rather than at a point on the backlight-side (incident-side) face of the display medium layer.

It should be noted that all of the disclosed details of Patent Documents 4 and 5 and Non-Patent Document 1 are herein incorporated by reference.

Patent Document 1: Japanese Laid-Open Patent Publication No. 11-109417

Patent Document 2: Japanese Laid-Open Patent Publication No. 2002-333619

Patent Document 3: Japanese Laid-Open Patent Publication 2003-255318

Patent Document 4: Japanese Patent Gazette No. 3151830

Patent Document 5: Japanese Laid-Open Patent Publication No. 2006-126732

Non-Patent Document 1: Kalil Kalantar et al. IDW'02, pages 509-512

### DISCLOSURE OF INVENTION

### Problems to be Solved by the Invention

However, as a result of examinations by the present inventors it has been found that a display device using an edge-light type backlight with high directivity as described in Non-Patent Document 1 and Patent Document 4 and light condensing elements has a problem that the planar distribution of luminance is not uniform. A variety of configurations have been conventionally examined for ensuring a uniform planar distribution for the luminance of light emerging from an edge-light type backlight. In such configurations, strictly for the purpose of ensuring a uniform planar distribution for the front luminance of the display panel, the peak luminance of a lighting device at positions corresponding to positions in the display panel plane has been fixed. However, in a display device provided with light condensing elements, in which the light condensing elements refract light emerging from the lighting device to be condensed into openings of pixels, in principle, and hence the luminance distribution of the display panel is different from the luminance distribution of the lighting device, use of the lighting device adjusted as described above will be of no help in ensuring a uniform planar distribution for the luminance of the display device provided with light condensing elements.

In view of the foregoing, the main object of the present invention is to ensure a uniform planar distribution for the luminance of a display device provided with a high-directivity edge-light type backlight and light condensing elements.

### Means for Solving the Problem

The display device of the present invention includes: a display panel including a plurality of pixels arranged in a matrix; a lighting device for irradiating the display panel with light from behind the display panel, including a light source and a light guide plate receiving light from the light source for outputting light toward the front; and a plurality of light condensing elements placed between the display panel and the lighting device, wherein the directivity of light emerging from the lighting device to be incident on the plurality of light condensing elements varies with the position in the plane of the display panel, and when the luminous flux of light emerging from the lighting device to be incident on the plurality of light condensing elements within the range of a polar angle of ±15° with respect to the normal to the display panel plane is Φ₁₅ and a region corresponding to a display region of the display panel plane is divided into nine equal regions, the minimum one of values of luminous flux Φ₁₅ at the centers of the nine regions is 70% or more of the maximum one of the values.

In one embodiment, the directivity of the light emerging from the lighting device to be incident on the plurality of light condensing elements varies depending on the azimuth in the display panel plane.

In another embodiment, the light guide plate has concave portions (linear grooves or discretely formed pits) or convex portions (linear ridges or discretely formed protrusions) arranged concentrically with the light source as the center on its back, and the directivity of the light emerging from the lighting device to be incident on the plurality of light condensing elements is smaller in an X direction than in a Y direction where the Y direction is a radial direction of a circle having its center at the light source and the X direction is orthogonal to the Y direction.

In yet another embodiment, the lighting device further includes a prism sheet placed at the front of the light guide plate, and the prism sheet has a corrugated pattern arranged concentrically with the light source as the center.

In yet another embodiment, when the peak luminance of the light emerging from the lighting device to be incident on the plurality of light condensing elements is Lp and a region corresponding to a display region of the display panel plane is divided into nine equal regions, the minimum one of values of peak luminance of the nine regions is less than 70% of the maximum one of the values.

In yet another embodiment, the plurality of light condensing elements are placed in a one-to-one correspondence with the plurality of pixels of the display panel.

In yet another embodiment, the display panel includes a first substrate, a second substrate and a liquid crystal layer placed between the first and second substrates, the first substrate is placed on the side of the liquid crystal layer closer to the lighting device and the second substrate is placed on the side of the liquid crystal layer closer to the observer, each of the plurality of pixels has a transmission region adapted to display in a transmission mode using light incident from the lighting device and a reflection region adapted to display in a reflection mode using light incident from the observer side, and the first substrate has, in a portion closer to the liquid crystal layer, a transparent electrode region for defining the transmission region and a reflective electrode region for defining the reflection region, and each of the light condensing elements is placed in correspondence with the transmission region of each of the plurality of pixels.

### Effects of the Invention

According to the present invention, the distribution of the luminance of a display device provided with a high-directivity edge-light type backlight and light condensing elements can be made uniform.

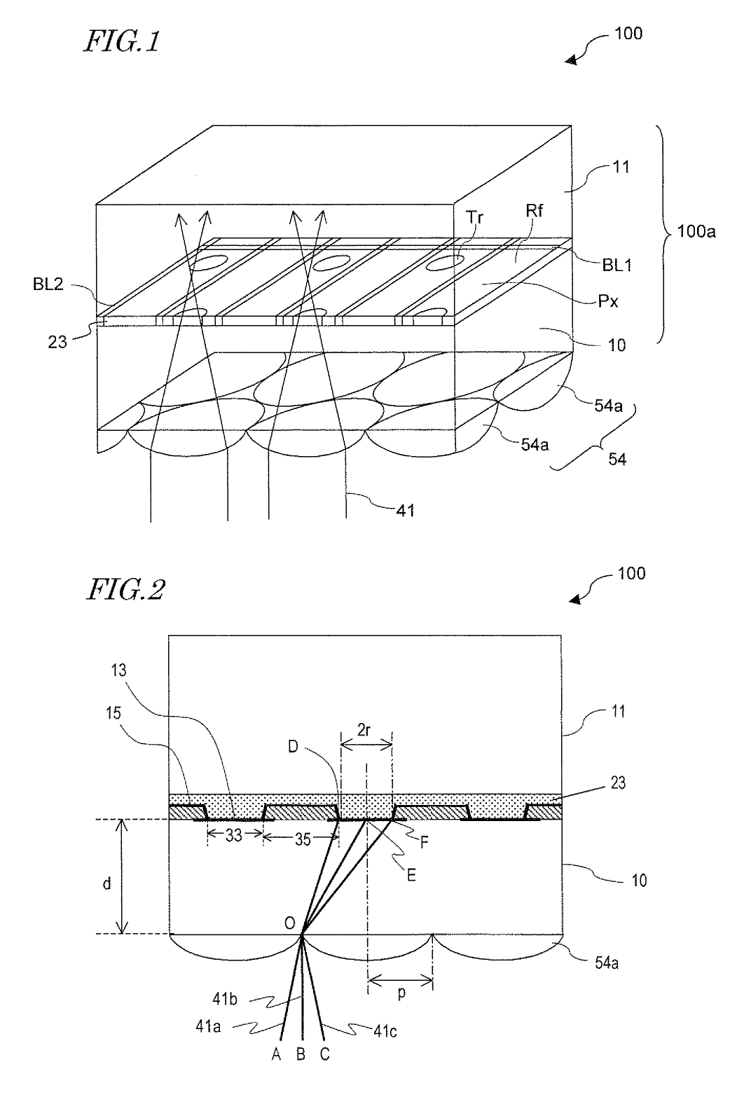

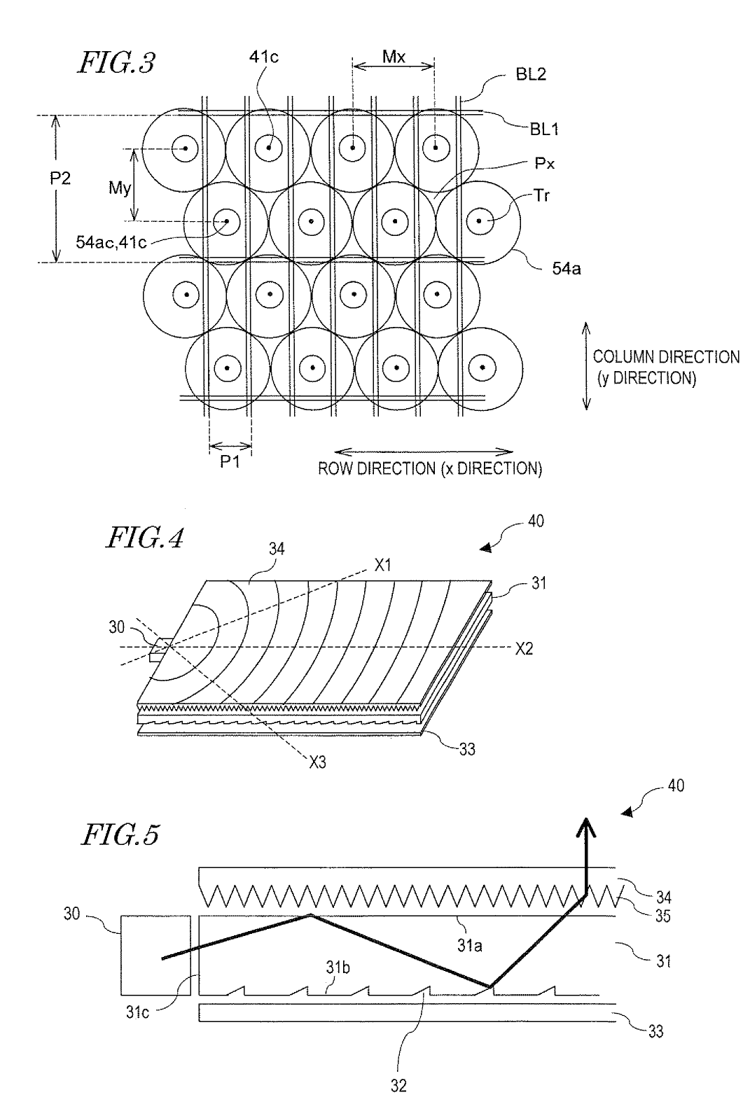

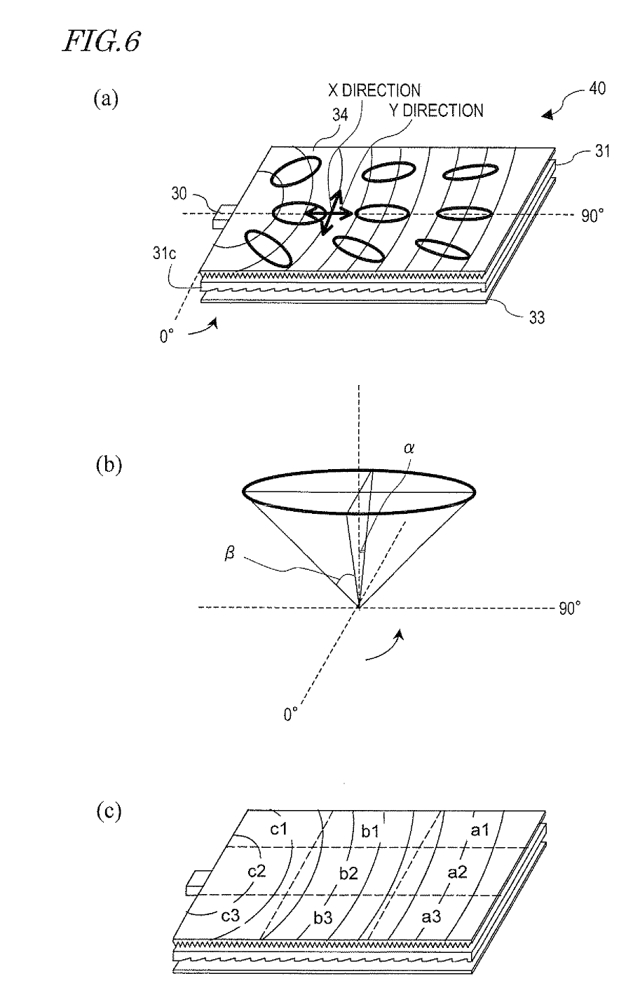

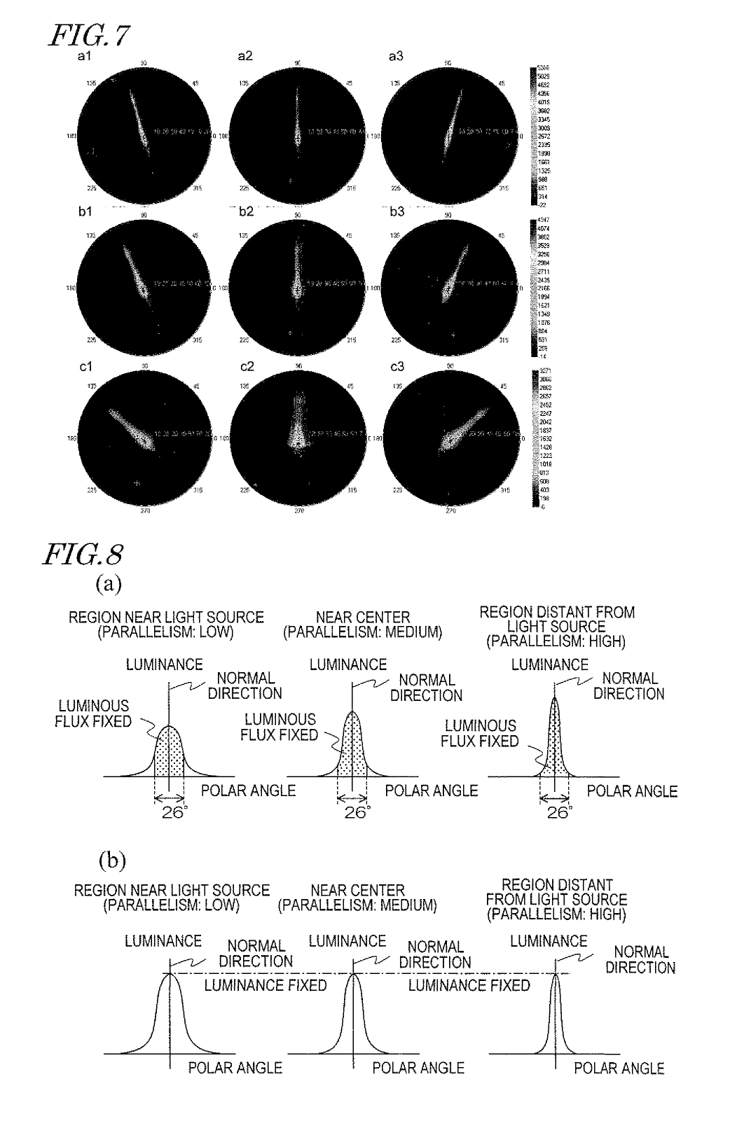

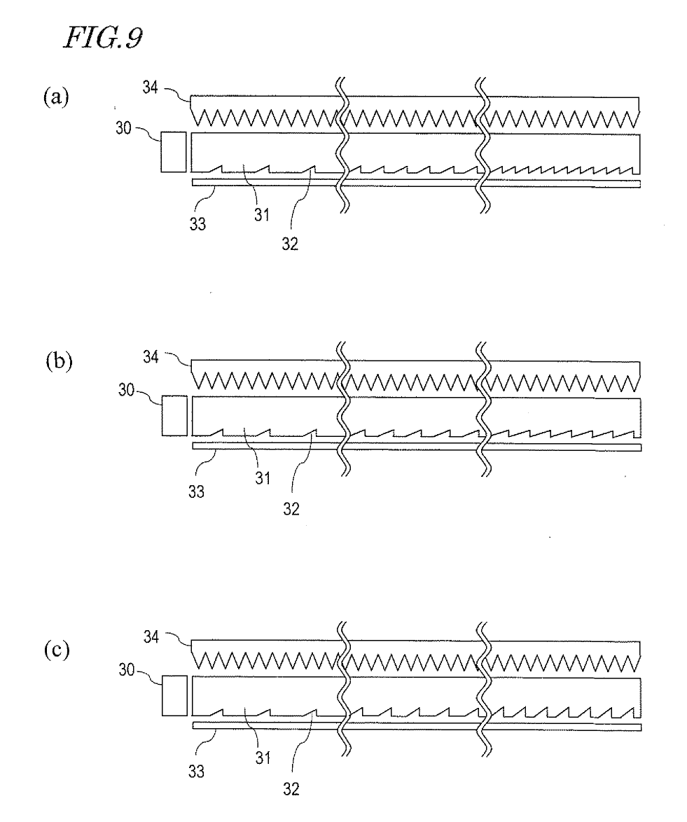

### BRIEF DESCRIPTION OF DRAWINGS

[FIG. 1] A perspective view diagrammatically showing a transflective liquid crystal display device of an embodiment of the present invention.

[FIG. 2] A view diagrammatically showing how light emerging from a high-directivity edge-light type backlight is incident on a display panel 100a via microlenses.

[FIG. 3] A plan view diagrammatically showing an example of the positional relationship between a microlens 54a and the center 41C of a condensed light spot and a corresponding transmission region Tr in a liquid crystal display device 100.

[FIG. 4] A perspective view diagrammatically showing a configuration of a high-directivity edge-light type backlight 40 suitably used for the liquid crystal display device 100.

[FIG. 5] A diagrammatic cross-sectional view of the high-directivity edge-light type backlight 40 suitably used for the liquid crystal display device 100, taken along any of lines X1, X2 and X3 in FIG. 4.

[FIG. 6](a) a view diagrammatically showing the luminance distribution of light emerging from the backlight 40, (b) a diagrammatic view for explaining the angular distribution of light emerging from the backlight 40, and (c) a diagrammatic view showing points at which the planar distribution of the luminance of light emerging from the backlight 40 is measured.

[FIG. 7] A view showing measurement results of the luminance distribution of the backlight 40 used for the liquid crystal display device 100 of an example.

[FIG. 8](a) is a view for explaining the planar distribution of the luminance of a backlight used for the liquid crystal display device of the embodiment of the present invention, and (b) is a view for explaining the planar distribution of the luminance of a conventional backlight.

[FIG. 9](a) to (c) are diagrammatic views for explaining methods for obtaining the planar bright distribution of a backlight used for the liquid crystal display device of the embodiment of the present invention.

### DESCRIPTION OF THE REFERENCE NUMERALS

10 First substrate (TFT substrate)

11 Second substrate (color filter substrate)

13 Transparent electrode

15 Reflective electrode

23 Liquid crystal layer

33 Transparent electrode region

35 Reflective electrode region

41 Light

50 Lighting device

54 Microlens array

54a Microlens

100a Display panel

10C Transflective liquid crystal display device

Tr Transmission region

Rf Reflection region

Px Pixel

### BEST MODE FOR CARRYING OUT THE INVENTION

A display device of an embodiment of the present invention will be described with reference to the relevant drawings. Hereinafter, the liquid crystal display device of an embodiment of the present invention will be described taking as an example a transflective liquid crystal display device provided with transmission regions adapted to display in the transmission mode and reflection regions adapted to display in the reflection mode. It should however be noted that the present invention is not limited to this but can be widely applied to display devices capable of conducting display in at least the transmission mode.

[Liquid Crystal Display Device]

FIG. 1 is a perspective view diagrammatically showing a transflective liquid crystal display device 100 of this embodiment. As shown in FIG. 3, the transflective liquid crystal display device 100 includes a lighting device (not shown), a display panel 100a having a plurality of pixels Px arranged in a matrix and a light condensing element group 54 placed between the lighting device and the display panel 100a.

The display panel 100a includes a first substrate 10 such as an active matrix substrate located closer to the lighting device, a second substrate 11 such as a color filter substrate located closer to the observer and a liquid crystal layer 23 placed between the first and second substrates 10 and 11.

The first substrate 10 has transparent electrode regions 33 (see FIG. 2) that transmit light 41 emerging from the lighting device and reflective electrode regions 35 (see FIG. 2) that reflect light (ambient light; not shown) incident from the second substrate 11. The first substrate 10 is provided with transparent electrodes 13 and reflective electrodes 15 formed to face the liquid crystal layer 23 (see FIG. 2), in which the reflective electrode regions 35 are defined by the reflective electrodes 15 while the transparent electrode regions 33 are defined as regions corresponding openings of the reflective electrodes 15 existing in the regions where the transparent electrodes 13 are formed. Although each transparent electrode 13 may be formed only in the corresponding transparent electrode region, formation of the transparent electrode over roughly the entire surface of each pixel as exemplified will give an advantage of stabilizing the subsequent process steps.

The display panel 100a further includes a color filter layer not shown having red (R) color filters, green (G) color filters and blue (B) color filters, in which the R, G and B color filters are arranged in stripes, for example. Three adjacent pixels Px in the row direction respectively output R, G and B color rays in correspondence with the R, and B color filters. Such three pixels constitute one color display pixel.

Each pixel Px has a transmission region Tr adapted to transmission-mode display and a reflection region Rf adapted to reflection-mode display, and hence can conduct display in the transmission mode and the reflection mode: it can conduct display in either one of the transmission and reflection modes, or in both modes. The plurality of pixels Px, arranged in a matrix, include kinds of pixels respectively outputting R, G and B color rays. Each pixel Px is defined by light-shading layers BL1 extending in the row direction and light-shading layers BL2 extending in the column direction. The light-shading layers BL1 may be composed of scanning signal lines, for example, and the light-shading layers BL2 may be composed of data signal lines, for example.

Note herein that the transparent electrode regions 33 and the reflective electrode regions 35 are defined as regions of the active matrix substrate such as a TFT substrate, while the pixels Px, the transmission regions Tr and the reflection regions Rf are defined as regions of the transflective liquid crystal display device 100.

The light condensing element group 54 of the transflective liquid crystal display device 100 includes a plurality of light condensing elements 54a, which are provided in a one-to-one correspondence with the transmission regions Tr of the pixels Px. In this embodiment, a microlens array 54 having a plurality of microlenses (light condensing elements) 54a is used as the light condensing element group 54.

The plurality of microlenses 54a of the microlens array 54 are provided in a one-to-one correspondence with the transmission regions Tr, and the center of the condensed light spot of light 41 having passed through each microlens 54a in the plane defined by liquid crystal layer portions of the plurality of pixels (hereinafter, this plane may sometimes be called the “pixel plane”; the pixel plane is parallel to the substrate plane) is located within the liquid crystal layer portion of the corresponding transmission region Tr.

The wording “condensed light spot” as used herein is distinguished from the point at which the cross-sectional area of a light beam is minimum, that is, the converging point (corresponding to the focal point of the microlens, for example). The “condensed light spot” corresponds to the cross-sectional profile of light in the pixel plane and does not necessarily agree with the converging point. The “center of the condensed light spot”, which is the center considering the luminance distribution of light in the pixel plane, corresponds to the center of gravity of a sheet of paper having an outline corresponding to the cross-sectional profile of the condensed light spot and also having a density distribution corresponding to the luminance distribution of light. When the luminance distribution of light is symmetric with respect to the geometric center of gravity of the cross-sectional profile of the condensed light spot, the “center of the condensed light spot” agrees with the geometric center of gravity. However, when the luminance distribution is asymmetric under the influence of an aberration of the microlens and the like, it may sometimes be deviated from the geometric center of gravity.

FIG. 3 is a plan view diagrammatically showing an example of the positional relationship between the microlens 54a and the center 41C of the condensed light spot and the corresponding transmission region Tr in the liquid crystal display device 100. The plurality of pixels are arranged in stripes with a pitch P1 in the row direction and a pitch P2 in the column direction. Any three adjacent pixels Px in the row direction respectively output R, G and B color rays, and such three pixels constitute one pixel. The plurality of microlenses 54a are placed so that the center 41C of the condensed light spot from each microlens is located within the corresponding transmission region Tr and also the center of the transmission region Tr and the center 41C of the condensed light spot roughly coincide with each other. FIG. 3 shows an example of arranging the microlenses in a closest packed state for the pixels arranged in stripes.

Since the center 41C of the condensed light spot is located in each pixel Px on a one-by-one basis, it agrees with the center of gravity of the condensed light spot. The centers 41C of the condensed light spots are zigzagged in each pixel row. The centers 410 of the condensed light spots located in any two adjacent pixels Px in the row direction are different in the position in the column direction: they do not exist at positions coinciding in the column direction in this way, by displacing the centers of the microlenses (centers of the condensed light spots) corresponding to any adjacent pixels in each pixel row from each other in the column direction, the microlenses can be arranged in a closest packed state even for the pixels arranged in stripes.

As shown in FIG. 3, the centers 41C of the condensed light spots are zigzagged so as to form two rows different in the position in the column direction in one pixel row. The pitch Mx of the centers 41C of the condensed light spots in the row direction in each row formed by the centers 41C of the condensed light spots is 2P1, and the two rows formed by the centers 41C of the condensed light spots in the same pixel row are deviated in pitch from each other by (1/2)Mx (=P1). Also, in the illustrated example, arrangement is made so that the pitch P2 of the pixels in the column direction and the pitch My of the centers 41C of the condensed light spots in the column direction satisfy the relationship P2=2My. Hence, the microlenses 54a circular in cross section in a plane parallel to the display plane are in an ideal closest packed array. The microlenses 54a shown in FIG. 3 are placed so that the ratio of Mx to My satisfies Mx:My=2:√3 and the packing factor of the microlenses 54a in the microlens array plane (plane parallel to the display plane) is π√3/6=0.906, which is maximum. Hence, 90.6% of the light amount incident on the display panel 100a from the lighting device 50 can be condensed and guided into the corresponding transmission regions to be used for display. With this, even when the area of the transmission regions is reduced for enhancement in the definition of the liquid crystal panel, bright transmission-mode display can be achieved. Likewise, even when the area proportion of the transmission region in each pixel Px is reduced for improvement of the luminance in the reflection mode, bright transmission-mode display can be achieved. Also, the ratio of the display luminance in the reflection mode to that in the transmission mode can be changed with the design of the lenses without the necessity of changing the area proportion for forming the reflective electrodes and the transparent electrodes.

In the liquid crystal display device 100, for enhancing the use efficiency of light from the lighting device, the converging point of light having passed through each transparent electrode region 33 of the first substrate 10 should preferably be formed at a position closer to the observer with respect to the liquid crystal layer 23, as is described in Patent Document 5.

[Edge-Light Type Backlight]

As a result of examinations by the present inventors, however, it has been found that while improving the luminance, the configuration described in Patent Document 5 causes a problem that the distribution of luminance in the display plane fails to be sufficiently uniform. Hereinafter, the features of a high-directivity edge-light type backlight suitably used for the liquid crystal display device 100 of the present invention will be described in comparison with a conventional high-directivity edge-light type backlight.

FIGS. 4 and 5 are views diagrammatically showing the configuration of a high-directivity edge-light type backlight 40 suitably used for the liquid crystal display device 100, in which FIG. 4 is a perspective view of the backlight 40 and FIG. 5 is a diagrammatic cross-sectional view taken along any of lines X1, X2 and X3 in FIG. 4. Note that since the conventional high-directivity edge-light type backlight and the backlight 40 are the same in basic structure, FIGS. 4 and are also referred to in description of the conventional backlight.

The backlight 40 includes a light source (LED, for example) 30, a light guide plate 31 receiving light from the light source 30, a reflector 33 placed on the back side of the light guide plate 31, and a prism sheet 34 placed on the front side of the light guide plate 31. The light guide plate 31 has a light emerging face (front face) 31a, a back face 31b opposing the light emerging face 31a and at least four side faces located between these faces. The light source 30 is placed at the center of one of the side faces (light incident face 31c) in the width direction. Concave portions (grooves or pits) 32 arranged concentrically with the light source as the center are formed on the back face 31b of the light guide plate 31. Although the concave portions 32 are formed in the illustrated example, convex portions may otherwise be formed. Also, the individual concave portions 32 may be linear grooves or discretely formed pits. Likewise, individual convex portions may be linear ridges or discretely formed protrusions. When light propagating inside the light guide plate 31 is incident on a concave portion 32, it is reflected from an inclined face of the concave portion 32 (an interface between the light guide plate 31 and the outside) changing its traveling direction. Part of the reflected light is incident on the light emerging face 31a of the light guide plate 31 at an angle smaller than the critical angle, and as a result, emerges outside the light guide plate 31. The prism sheet 34 has a corrugated pattern (prisms) 35 arranged concentrically with the light source as the center formed on the face thereof facing the light emerging face 31a of the light guide plate 31, for modifying the angular distribution of light emerging from the light emerging face 31a of the light guide plate 31. For example, the prim sheet modifies the angular distribution of the emerging light so as to increase the front luminance. The reflector 33 placed on the back side of the light guide plate 31 allows light emerging from the back face 31b of the light guide plate 31 to reenter the light guide plate 31, to contribute to improving the use efficiency. The light guide plate 31 is made of a transparent material such as an acrylic material. It should be noted that the expression that the concave portions 32 and the corrugated pattern 35 are “arranged concentrically” does not necessarily mean that the individual concave portions 32 and the individual projections/depressions of the corrugated pattern 35 form a circle, but may be part of a circle (see FIGS. 9 and 26 of Patent Document 4, for example).

In the backlight 40 having the configuration described above, most of the light that is emitted from the light source 30, enters the light guide plate 31 and propagates inside the light guide plate 31 radially is incident vertically on the concave portions 32 and the corrugated pattern 35. Hence, the light is easily outputted in the direction normal to the light emerging face 31a efficiently and thus has a directivity close to parallel light (narrow luminance distribution) though not being completely parallel light. The luminance distribution of light emerging from the backlight 40 is diagrammatically shown in FIG. 6(a). FIG. 6(b) is a diagrammatic view for explaining the angular distribution of light emerging from the backlight 40.

As shown in FIG. 6(a), the luminance distribution (angular distribution) of light emerging from the backlight 40 is wide in the radial direction (referred to as the Y direction) of concentric circles having the center at the position of the light source 30 and narrow in the direction (referred to as the X direction) orthogonal to the radial direction. In other words, the parallelism is low when the azimuth in the display panel plane is the Y direction and high when it is the X direction; hence the directivity of the emerging light varies depending on the azimuth in the plane of the display panel.

As shown in FIG. 6(b), the angular distribution of light emerging from a certain point in the display panel-side plane of the backlight 40 is characterized by the shape of an ellipse whose minor and major axes are respectively in the azimuth directions small in polar angle (α) and large in polar angle (β). In FIG. 6(a), such ellipses are shown in correspondence with positions on the light emerging face 31a of the backlight 40. The major axis of each ellipse is parallel to the radial direction of concentric circles having the center at the light source 30 (Y direction), and the minor axis is parallel to the direction orthogonal to the Y direction (X direction). It is herein assumed that as shown in FIG. 6(b), the azimuth angle of the direction parallel to the light incident face 31c of the light guide plate 31 (direction downward as viewed from the figure) is 0° and that the counterclockwise direction is the regular direction. Hence, the azimuth angle determined by the normal drawn from the light source 30 to the light incident face 31c is 90°.

As shown in FIG. 6(a), the directivity of the emerging light not only varies depending on the azimuth in the display panel plane, but also varies with the position in the display panel plane (i.e., has a planar distribution). That is, as the distance from the light source 30 is longer, the minor axis of the ellipse is shorter. In other words, the directivity in the X direction enhances. This dependence of the directivity of the emerging light on the position (on the distance from the light source) occurs due to the following reason.

As the distance from the light source 30 is longer, an increased number of light rays are incident on the concave portions 32 of the light guide plate 31 and the corrugated pattern 35 of the prism sheet 34 at an incident angle close to 90°. Hence, the directivity in the X direction enhances (the half-width is narrowed) by this increase.

When the directivity of light emerging from the backlight varies, a difference arises in the light condensing efficiency with the light condensing elements even if the peak luminance (maximum luminance) is the same: while light high in directivity (parallelism) is condensed efficiently, light low in directivity (parallelism) is condensed with low efficiency. This indicates that the luminance distribution (peak luminance, for example) of light having passed through a light condensing element varies with the directivity of light entering the light condensing element.

According to the technique described in Patent Document 5, in use of light varying in directivity with the azimuth (for example, light having a half-width exceeding ±5° in the X direction and 5° or more in the Y direction), the light amount passing through the pixels can be increased (the display luminance can be improved) by forming the light converging point at a position closer to the observer with respect to the liquid crystal layer 23. Using the technique described in Patent Document 5, however, while the use efficiency of light varying in directivity with the azimuth can be enhanced, the non-uniformity of the planar distribution of luminance caused because the light directivity varies with the position cannot be overcome.

In the backlight 40 provided in the liquid crystal display device 100 of this embodiment of the present invention, the luminance distribution of light emerging from the backlight 40 is adjusted so that the planar distribution of the luminance of light having passed through the light condensing elements (microlenses) is uniform. Specifically, in the light emerging plane of the backlight 40, adjustment is made so as to reduce the luminance in a region low in the parallelism of the emerging light (region near the light source 30) and increase the luminance in a region high in the parallelism (region distant from the light source 30). This will be specifically described as follows with reference to FIG. 2.

In FIG. 2, assume that the thickness of the first substrate 10 is d, the radius of each microlens 54a as viewed in the direction normal to the substrate is p, and the shape of each transparent electrode region 33 is a circle having a radius of r. The microlens 54a is formed so as to allow parallel light incident in the direction normal to the substrate to converge at the center of the transmission region 33. Although it is naturally preferred to adopt the technique described in Patent Document 5 for enhancing the light use efficiency, the above setting is herein made for simplifying the description.

Light emerging from the high-directivity edge-light type backlight 40 described above is incident on each microlens 54a with a slight spread (represented by the polar angle) from the direction normal to the substrate. Hence, light incident on the microlens 54a is condensed on the transmission region 33 with some spread having its center at the center of the transmission region 33.

In FIG. 2, a light ray 41a is light passing through an edge O of a microlens 54a toward an edge F of a transmission region 33, a light ray 41b is light passing through the edge O of the microlens 54a toward the center E of the transmission region 33, and a light ray 41c is light passing through the edge O of the microlens 54a toward an edge D of the transmission region 33.

According to geometrical optics, it is found from FIG. 2 that in the liquid crystal display device 100 using the microlenses 54a, light used for display after having passed through the microlenses 54a and then the transmission regions 33 is light emerging at an angle within the interior of ∠AOC out of the light emerging from the backlight 40. It is therefore found that, to obtain a uniform planar luminance distribution in a display device using light condensing elements, the planar distribution of the luminance of light emerging within the interior of ∠AOC whose center is the direction normal to the substrate should be made uniform. Conventionally, strictly for the purpose of making the front luminance of the display panel uniform, the peak luminance of a lighting device at positions corresponding to positions in the display panel plane was made uniform. Hence, the planar distribution of the luminance of a display device provided with light condensing elements failed to be uniform.

The angle ∠AOC can be approximately calculated based on geometrical optics from expression (1):

∠AOC≈n×sin⁻¹(∠DOF) (1)

where n is the refractive index of the first substrate.

The degree of spread of light emerging from the backlight and incident on a light condensing element is herein represented by the polar angle with respect to the normal to the display panel plane. The angle ∠AOC may sometimes be represented by 2ω (or ±ω), where the unit of ω is “° (degree).”

The intensity of light within the range of a specific polar angle is represented by the luminous flux Φ. Specifically, the angular distribution of luminance is measured with a luminance meter (EZContrast from ELDIM), and the resultant luminance data is converted to luminous flux data (luminance/cos θ×solid angle Ω, θ: polar angle) to obtain a luminous flux Φ within the range of the specific polar angle. Note that the solid angle Ω has a relationship with the polar angle θ of Ω[sr]=2π(1−cos θ).

The liquid crystal display device 100 having the configuration described above was prototyped and the luminance distribution in the display panel plane was evaluated. The evaluation results are described as follows. The basic configuration of the prototyped liquid crystal display device is as follows.

Lighting device: a high-directivity edge-light type backlight having one LED (FIG. 4)

Microlenses: refractive index 1.5, radius of curvature 60 μm, radius p as viewed in the direction normal to the substrate 51 μm

First substrate: refractive index 1.5 (glass), thickness 0.12 mm

Second substrate: refractive index 1.5 (glass), thickness 0.7 mm

Pixels: pitch in the row direction 51 μm, pitch in the row direction 153 μm

Transparent electrode regions: circles of 2r=42 μm (aperture ratio of transparent electrode regions: about 18%)

In the liquid crystal display device having the above basic configuration, ∠DOF is 17° from geometrical optics calculation, and hence from expression (1) above, ∠AOC≈n×sin⁻¹(∠DOF)=1.5×sin⁻¹(17°)=26° can be obtained.

For the liquid crystal display device 100 of this example, used was the backlight 40 in which the luminance distribution of the high-directivity lighting device was adjusted so that the luminous flux Φ₁₃ of light emerging within the range of a polar angle of ±13° (total 26°) with respect to the normal to the display plane as the center was uniform in the display plane. For a liquid crystal display device of a comparative example, used was a conventional backlight adjusted so that the peak luminance was uniform in the display plane.

The uniformity in the display plane was determined in the following manner: a region corresponding to the display region was divided into nine equal regions, to measure the luminous flux Φ₁₃ and the peak luminance at the center of each of the nine regions and, if the minimum value of the measurement was 70% or more of the maximum thereof, the luminance flux or the peak luminance was determined uniform. The criterion of the evaluation of 70% is the level judged free of any problem from subjective evaluation and also the level actually adopted in hitherto available commercial products.

FIG. 7 shows the results of measurement of the luminance distribution of the backlight 40 used for the liquid crystal display device 100 of this example with a luminance meter (EZContrast from ELDIM). Measured points a1 to a3, b1 to b3 and c1 to c3 are the centers of nine regions obtained by dividing a region corresponding to the display region of the light emerging face of the backlight 40 into nine equal parts, as diagrammatically shown in FIG. 6(c). In each of views showing the luminance distribution, the radius direction represents the polar angle θ and the circumferential direction represents the azimuth angle. The direction of an azimuth angle of 0° is parallel to the the incident face 31c of the light guide plate 31 as shown in FIG. 6(a). As is apparent from FIG. 7, the angular distribution of luminance at each point has azimuth angle dependence as described above and also has position dependence. For example, in the angular distributions of luminance in the X direction at the measured points a2, b2 and c2 in the center portion of the light guide plate 31, the luminance distribution is narrowest at a2 longest in the distance from the light source 30, widest at c2 shortest in the distance from the light source 30 and moderately spreads at b2 in the middle between the above two points. The luminance distributions were also measured in substantially the same manner for the backlight of the comparative example. The results of these measurements are summarized in Table 1 below. Table 1 also shows the peak luminance (front luminance) and total luminous flux of the liquid crystal display devices prepared using these backlights (as measured after passing through the panels provided with lenses).

TABLE 1

| | | | | | | Backlight uniform in luminous flux | | | | |
|---|---|---|---|---|---|---|---|---|---|---|
| | Backlight uniform in front luminance | | | | | within 15° | | | | |
| | | | | After passing | | | | | After passing | |
| | BL | | | through lens- | | BL | | | through lens- | |
| | | | Luminous | equipped panel | | | | Luminous | equipped panel | |
| | | Total | flux | | Total | | Total | flux | | Total |
| Positions | Peak | luminous | within | Peak | luminous | Peak | luminous | within | Peak | luminous |
| measured | luminance | flux | 15° | luminance | flux | luminance | flux | 15° | luminance | flux |
| a1 | 4861 | 228 | 86 | 281 | 315 | 5413 | 233 | 110 | 115 | 118 |
| a2 | 4211 | 206 | 84 | 264 | 297 | 6106 | 218 | 113 | 124 | 120 |
| a3 | 4749 | 242 | 87 | 281 | 326 | 5297 | 235 | 109 | 118 | 118 |
| b1 | 4268 | 212 | 108 | 328 | 360 | 4754 | 268 | 147 | 149 | 150 |
| b2 | 3731 | 186 | 100 | 317 | 327 | 3667 | 211 | 120 | 120 | 121 |
| b3 | 4466 | 225 | 115 | 370 | 375 | 4310 | 255 | 137 | 147 | 147 |
| c1 | 3604 | 232 | 122 | 394 | 414 | 3297 | 250 | 130 | 133 | 142 |
| c2 | 4025 | 318 | 186 | 641 | 705 | 2935 | 250 | 140 | 126 | 141 |
| c3 | 3727 | 255 | 136 | 430 | 465 | 3252 | 261 | 134 | 146 | 145 |
| Ave. | 4182 | 234 | 114 | 367 | 398 | 4337 | 242 | 127 | 131 | 134 |
| Distribution | 74% | 58% | 45% | 41% | 42% | 48% | 79% | 74% | 77% | 79% |

The “distribution” in Table 1 represents the ratio of the minimum value to the maximum value in percentage.

The total luminous flux is shown together with the luminous flux Φ₁₅ within a polar angle of ±15°. Although the luminous flux Φ₁₅ was shown in the above table, the distribution of the luminous flux Φ₁₃ within a polar angle of ±13° was also 70% or more, and both the distributions of the peak luminance and total luminous flux after passing through the lens-equipped panel were also 70% or more. The polar angle ω=∠AOC/2 with which the luminous flux of emerging light is fixed is determined appropriately from the size and shape of the openings (transmission regions) of the display panel and the thickness of the first substrate according to expression (1). Hence, it is merely required to produce a backlight that allows the luminous flux Φω within the polar angle ±ω of the emerging light to be uniform based on the specifications of the display panel. Note however that since it has been found, as a result of examinations of the luminance distributions of various high-directivity edge-light type backlights, that the distributions of both the peak luminance and total luminous flux after passing through the lens-equipped panel can be 70% or more as long as the distribution of the luminous flux Φ₁₅ within ω=15° is 70% or more, a liquid crystal display device permitting display having comparatively uniform luminance can be obtained by adopting a backlight merely having a distribution of the luminous flux Φ₁₅ of 70% or more without the necessity of preparing a backlight strictly according to expression (1). This is especially advantageous in that the development cost of the backlight can be reduced.

The comparative example in Table 1 will first be described. In the conventional high-directivity edge-light type backlight, adjusted so that the planar distribution of the peak luminance is uniform, the planar distribution of the peak luminance is 74% exhibiting sufficient uniformity. However, the distributions of the peak luminance and total luminous flux after passing through the lens-equipped panel are as low as 41% and 42%, respectively, which are observed by the observer as non-uniformity in the planar distribution of the display luminance. The distribution of Φ₁₅ of this conventional high-directivity edge-light type backlight is very low, i.e., 45%, and this non-uniformity is a cause of the non-uniformity of the luminance after passing through the lenses.

Contrary to the above, in the inventive example in Table 1, it is found that the planar distribution of Φ₁₅ of the edge-light type backlight is as high as 74%, and as a result, the distributions of the peak luminance and total luminous flux after passing through the lens-equipped panel are very high, i.e., 77% and 79%, respectively. In this way, by achieving a planar distribution of Φ₁₅ of the edge-light type backlight of 70% or more, the distributions of the peak luminance and total luminous flux after passing through the lens-equipped panel can be made 70% or more. The planar distribution of the peak luminance of the thus-adjusted edge-light type backlight is 48%, which is very small.

Referring to FIGS. 8(a) and 8(b), the difference in the planar distribution of the luminance between the inventive example and the comparative example will be described in a conceptual manner.

As diagrammatically shown in FIG. 8(a), the backlight used for the liquid crystal display device of this example has been adjusted so that the luminous flux Φ₁₃ within a polar angle of ±13° (total 26°) is uniform in the display region. Hence, the peak luminance is small in regions near the light source (c1 to c3 in FIG. 6(c)) and large in regions distant from the light source (a1 to a3 in FIG. 6(c)). On the contrary, as diagrammatically shown in FIG. 8(b), the conventional backlight used for the liquid crystal display device of the comparative example has been adjusted so that the peak luminance is fixed. In other words, the backlight used for the liquid crystal display device of the embodiment of the present invention can only be obtained by varying the peak luminance positively contrary to the conventional technical common knowledge, to increase the peak luminance as the distance from the light source is longer.

Referring to FIGS. 9(a) to 9(c), methods for achieving the planar distribution of the luminance shown in Table 1 and FIG. 8 will be described. The liquid crystal display device of the embodiment of the present invention is characterized in the planar distribution of the luminance, and known methods can be used for adjustment of the planar distribution of the luminance, which will be described briefly as follows.

Referring to FIG. 9(a), as the distance from the light source 30 is longer, the pattern density of the concave portions 32 formed on the back of the light guide plate. 31 is increased, more abruptly than conventionally done. In other words, the degree at which the number of concave portions 32 included per unit length increases as the distance from the light source 30 is longer is made greater than conventionally done.

Referring to FIG. 9(b), as the distance from the light source 30 is longer, the pattern of the concave portions formed on the back of the light guide plate 31 is made greater.

Referring to FIG. 9(c), as the distance from the light source 30 is longer, the tilt angle of the inclined face (functioning as the reflection face), facing the light source 30, of each concave portion 32 formed on the back of the light guide plate 31 is made greater.

Naturally, the methods shown in FIGS. 9(a) to 9(c) can be freely combined, or otherwise the light guide plate 31 may be made thinner as the distance from the light source 30 is longer.

### INDUSTRIAL APPLICABILITY

The present invention can be suitably applied to medium to small sized liquid crystal display devices such as transflective liquid crystal display devices, for example.

1. A display device comprising:
a display panel including a plurality of pixels arranged in a matrix;
a lighting device for irradiating the display panel with light from behind the display panel, comprising a light source and a light guide plate receiving light from the light source for outputting light toward the front; and
a plurality of light condensing elements placed between the display panel and the lighting device,
wherein the directivity of light emerging from the lighting device to be incident on the plurality of light condensing elements varies with the position in the plane of the display panel, and
when the range of a polar angle of light, out of the light emerging from the lighting device to be incident on the plurality of light condensing elements, that is used for display after passing through the plurality of light condensing elements and then the display panel, with respect to the normal to the display panel plane determined based on geometrical optics is ±ω or less and the luminous flux within the range of the polar angle ±ω is Φω,
the minimum one of values of luminous flux Φω at the centers of nine regions, obtained by dividing a region corresponding to the display region of the display panel plane into nine equal parts, is 70% or more of the maximum one of the values.

2. A display device comprising:
a display panel including a plurality of pixels arranged in a matrix;
a lighting device for irradiating the display panel with light from behind the display panel, comprising a light source and a light guide plate receiving light from the light source for outputting light toward the front; and
a plurality of light condensing elements placed between the display panel and the lighting device,
wherein the directivity of light emerging from the lighting device to be incident on the plurality of light condensing elements varies with the position in the plane of the display panel, and
when the luminous flux of light emerging from the lighting device to be incident on the plurality of light condensing elements within the range of a polar angle of ±15° with respect to the normal to the display panel plane is Φ₁₅ and a region corresponding to a display region of the display panel plane is divided into nine equal regions, the minimum one of values of luminous flux Φ₁₅ at the centers of the nine regions is 70% or more of the maximum one of the values.

3. The display device of claim 1, wherein the directivity of the light emerging from the lighting device to be incident on the plurality of light condensing elements varies depending on the azimuth in the display panel plane.

4. The display device of claim 3, wherein the light guide plate has concave or convex portions arranged concentrically with the light source as the center on its back, and
the directivity of the light emerging from the lighting device to be incident on the plurality of light condensing elements is smaller in an X direction than in a Y direction where the Y direction is a radial direction of a circle having its center at the light source and the X direction is orthogonal to the Y direction.

5. The display device of claim 4, wherein the lighting device further comprises a prism sheet placed at the front of the light guide plate, and the prism sheet has a corrugated pattern arranged concentrically with the light source as the center.

6. The display device of claim 1, wherein when the peak luminance of the light emerging from the lighting device to be incident on the plurality of light condensing elements is Lp and a region corresponding to a display region of the display panel plane is divided into nine equal regions, the minimum one of values of peak luminance of the nine regions is less than 70% of the maximum one of the values.

7. The display device of claim 1, wherein the plurality of light condensing elements are placed in a one-to-one correspondence with the plurality of pixels of the display panel.

8. The display device of claim 1, wherein the display panel comprises a first substrate, a second substrate and a liquid crystal layer placed between the first and second substrates, the first substrate is placed on the side of the liquid crystal layer closer to the lighting device and the second substrate is placed on the side of the liquid crystal layer closer to the observer,
each of the plurality of pixels has a transmission region adapted to display in a transmission mode using light incident from the lighting device and a reflection region adapted to display in a reflection mode using light incident from the observer side, and the first substrate has, in a portion closer to the liquid crystal layer, a transparent electrode region for defining the transmission region and a reflective electrode region for defining the reflection region, and
each of the light condensing elements is placed in correspondence with the transmission region of each of the plurality of pixels.

9. The display device of claim 2, wherein the directivity of the light emerging from the lighting device to be incident on the plurality of light condensing elements varies depending on the azimuth in the display panel plane.

10. The display device of claim 9, wherein the light guide plate has concave or convex portions arranged concentrically with the light source as the center on its back, and
the directivity of the light emerging from the lighting device to be incident on the plurality of light condensing elements is smaller in an X direction than in a Y direction where the Y direction is a radial direction of a circle having its center at the light source and the X direction is orthogonal to the Y direction.

11. The display device of claim 10, wherein the lighting device further comprises a prism sheet placed at the front of the light guide plate, and the prism sheet has a corrugated pattern arranged concentrically with the light source as the center.

12. The display device of claim 2, wherein when the peak luminance of the light emerging from the lighting device to be incident on the plurality of light condensing elements is Lp and a region corresponding to a display region of the display panel plane is divided into nine equal regions, the minimum one of values of peak luminance of the nine regions is less than 70% of the maximum one of the values.

13. The display device of claim 2, wherein the plurality of light condensing elements are placed in a one-to-one correspondence with the plurality of pixels of the display panel.

14. The display device of claim 2, wherein the display panel comprises a first substrate, a second substrate and a liquid crystal layer placed between the first and second substrates, the first substrate is placed on the side of the liquid crystal layer closer to the lighting device and the second substrate is placed on the side of the liquid crystal layer closer to the observer,
each of the plurality of pixels has a transmission region adapted to display in a transmission mode using light incident from the lighting device and a reflection region adapted to display in a reflection mode using light incident from the observer side, and the first substrate has, in a portion closer to the liquid crystal layer, a transparent electrode region for defining the transmission region and a reflective electrode region for defining the reflection region, and
each of the light condensing elements is placed in correspondence with the transmission region of each of the plurality of pixels.
